(19) United States
(12) Patent Application Publication
(10) Pub. No.: US 2017/0316467 A1
(43) Pub. Date: Nov. 2, 2017

(54) System and Methods for Determining Advertising Visibility on Web Pages

(71) Applicant: Oracle America, Inc., Redwood Shores, CA (US)

(72) Inventors: Michael Garrett Seiler, Scarsdale, NY (US); David Jon Titus, Mount Airy, MD (US); Christopher Ross Tsoufakis, Salt Lake City, UT (US); Daniel Evan Fichter, New York, NY (US); Nikki Kyle Gomez, Brooklyn, NY (US); Jonah Goodhart, Ithaca, NY (US); Aniq Rahman, New York, NY (US)

(73) Assignee: Oracle America, Inc., Redwood Shores, CA (US)

(21) Appl. No.: 13/945,851

(22) Filed: Jul. 18, 2013

Related U.S. Application Data
(60) Provisional application No. 61/673,885, filed on Jul. 20, 2012.

(51) Int. Cl. G06Q 30/02

(52) U.S. Cl. CPC G06Q 30/0277

(57) ABSTRACT

The system and methods of the present technology are configured to determine the in-view status of advertising from within an iframe configured to display the advertising, without relying on code operating the hosted web page bearing the advertising. The system and methods use a plug-in or applet resident in a client device and the application programming interface (API) of the client device, in combination, to determine if the advertising is in-view or not, by superimposing one or more invisible animation frames over a screen area occupied by the advertising. Each superimposed invisible animation frame has access to data on view-ability. The application programming interface (API) by examining the frame rate progression of the one or more invisible animation frames determines if the advertising on which the invisible animation frames are superimposed is in fact in-view and then reports this information to a server configured to collect this data.

### CROSS REFERENCE TO RELATED APPLICATIONS

The present application claims the benefit of priority under 35 U.S.C. §119(e) of U.S. Provisional Application No. 61/673,885 entitled “System and Method for Determining Advertising Visibility on Web Pages,” filed on Jul. 20, 2012, by Michael Garrett Seiler, David J. Titus, Chris Tsoufakis, and Dan Fichter. The entire contents of the provisional application are incorporated by reference herein.

### BACKGROUND

This invention relates to determining whether content delivered over a network, in particular, advertising is visible to a viewer. In particular, this invention relates to a system and methods for determining visibility of advertising on web pages by inferring information from frame rates of video plug-ins.

Online publication has replaced traditional ways of distributing content. Publishers of online content monetize the content they produce by either invoking a pay-per-view payment scheme or subscription scheme. Yet, there are many publishers who offer free content to the public, yet only with relying on advertising.

For placement of advertising on a website, appropriate and fair pricing for the spaces where advertising will be placed, must be determined. Advertising spaces may be sold on either a pay-per-impression viewing or on a pay-per-click basis. In a pay-per-impression advertising scenario, a charge is imposed each time the web page containing a particular advertisement is viewed. This is facilitated by records that are maintained to reflect every instance that a particular advertisement is downloaded by a user. In this scenario, the advertiser is charged for the volume of downloads that have occurred in relation to the particular advertisement served by it. Yet, this scenario is hardly accurate, as there is no easy way of determining if viewers have viewed a particular advertisement, much less adequately viewed it for the advertisement to make an impression on the viewer. In many instances, advertising may be located on a portion of the web page that is not easily viewed in a user's browser window. In some instance, the advertising may not have loaded. This uncertainty bears on the value of a particular advertisement to the advertiser, and thereby negatively impacts perceptions about internet advertising.

Standards for the advertising industry were established in the year 2011 to recommend measuring the effectiveness of advertising for online display and according a fair monetary value only in the event that viewers had the opportunity to actually view a particular advertisement on online display. As indicated above, in many instances, advertisements are placed on a web page in a location that does not even appear in the portion of a computer screen that may be easily viewed by viewers. In other words, the advertisements are not “in-view,” unless the user takes express action to scroll down the web page. Such placement of advertising, also referred to as “below the fold,” occurs with respect to approximately half the advertising inventory for online display.

In order to comply with the industry recommendations to count only “in-view” impressions, any computer program configured to count impressions, must register the location of a particular advertisement on the web page being viewed as well as the location of the scroll bar as it appears on a viewer's computer screen. Yet, the common practice of inserting advertising in security-protected areas on web pages (e.g., cross-domain or in “hostile” iframes) does not make this information easily accessible to such computer programs. Advertising is often contained within iframes in a host web page which are sometime nested. An iframe refers to a region within a web page in which other web content may appear. An iframe serves an important benefit to publishers, because the content within the iframe cannot affect content in the host web page or even discover information regarding that web page, as long as the iframe and the host web page are served from different domains. This allows the publisher to be certain that a particular advertisement will not infect or alter the main content on the host web page. One drawback lies in the fact that because content within the iframe is unable to interact with the host web page, it is practically impossible for any client-side code served with the advertisement to discover, for example, the dimensions (e.g., height and width) of the host web page, or where the browser viewport may be in relation to the host web page. Accordingly, it is impossible for any such client-side code to be used to discover whether a particular advertisement may be “in-view.” When an advertisement is served within an iframe, any attempts to infer if an advertisement is “in-view” from the location of the browser viewport relative to the host web page simply do not function, and reveal that information. Currently, only a computer program that has access to all the information on a webpage can provide an estimate of content that is “in-view.”

Another significant drawback is that there is no way for advertisers to determine if the money they spend on advertising actually resulted in an advertisement that facilitated viewing by viewers without relying on publisher-provided information. This results in a conflict of interest for publishers, who may benefit by charging for advertising space that is not “in-view.” Therefore, publishers are inclined not to share that information.

Accordingly, it would be desirable to provide a technique for establishing whether an advertisement has been viewed, even when the advertisement is served within an iframe or some other such restricted or environment.

### SUMMARY

The system and methods of the present technology overcome the constraints presented by iframe security to determine the “in-view” status of an advertisement from within a restricted area, for example an i-frame, without relying on code (e.g., JavaScript) operating outside the restricted area. The system and methods of the present technology use a plug-in or applet (e.g., Adobe Flash), and code (including JavaScript or other common programming language) resident on a client device (e.g., personal computers) in combination to determine if the advertisements placed on a hosted web page for display are “in-view” or not. The system and methods of the present technology monitor or track a characteristic embedded in the client device, in some instances in the advertising itself and monitor variations in the characteristic embedded. In some implementations, the system and methods of the present technology intentionally superimpose one or more invisible animation frames over a screen area occupied by an advertisement. Each superimposed invisible animation has access to data regarding “view-ability” or “visibility” (both are interchangeably used) that would otherwise be inaccessible to the embedded code (e.g., JavaScript) measuring “in-view” status. The embedded code (e.g., JavaScript), by examining the frame rate progression of the invisible animations, is configured to determine if an advertisement on which the animation is superimposed is in fact “in-view.”

The present system is configured to determine whether an area bearing advertising within a hosted web page is in-view, and comprises one or more processors and memory storing instructions that, when executed, cause the system to superimpose at least one invisible animation frame on at least a portion of the area bearing the advertising, render the web page, monitor a frame rate progression characteristic relating to the at least one invisible animation frame, and determine from the frame rate progression characteristic whether the portion of the area bearing the advertising is in-view or not in-view, wherein the frame rate progression characteristic varies according to whether the at least one invisible animation frame is in-view or not in view.

The present methods are configured to determine whether an area bearing advertising within a hosted web page is in-view, and comprise operations for superimposing at least one invisible animation frame on at least a portion of the area bearing the advertising, rendering the web page, monitoring a frame rate progression characteristic relating to the at least one invisible animation frame, and determining from the frame rate progression characteristic whether the portion of the area bearing the advertising is in-view or not in-view, wherein the frame rate progression characteristic varies according to whether the at least one invisible animation frame is in-view or not in view.

### BRIEF DESCRIPTION OF THE DRAWINGS

The present disclosure is illustrated by way of example, and not by way of limitation, in the figures of the accompanying drawings, in which like reference numerals are used to refer to similar elements.

FIG. 1 is a block diagram of example client-server system architecture of the present invention for delivery of advertising including an analytics and visibility server and a client device with a visibility plug-in, applet, or the like.

FIG. 2A is a block diagram illustrating example hardware components of the client device.

FIG. 2B is a block diagram illustrating example software components of the visibility plug-in, applet, or the like.

FIG. 3 is a block diagram illustrating example hardware components of the analytics and visibility server illustrated in FIG. 1.

FIG. 4 is a flow chart illustrating an example general process for determining visibility of advertising on web pages by inferring information from frame rates of video plug-ins, applets, or the like.

FIGS. 5A and 5B illustrate a flow chart of a specific example for determining the visibility status of an advertisement based on frame rates of animations (invisible).

FIG. 6 is a graphic representation illustrating an example browser with an advertisement and several animation frames.

FIG. 7 is diagram illustrating an example data storage configuration with various examples of criteria for data and/or entities that are stored in the analytics and visibility server.

### DETAILED DESCRIPTION

The system and methods of the present technology overcome the constraints presented by iframe security to determine, monitor, or track the “in-view” status of an advertisement from within an iframe, without relying on code or Application Programming Interface (API) (e.g., JavaScript) operating outside the iframe (e.g., on the hosted web page). In this context, “in view” indicates that the region in which the advertisement is displayed falls within a browser's viewport, i.e., within a “viewable” portion of a hosted web page that is shown by the browser. However, while it is necessary that the presence of the region in which the advertisement is displayed is within the browser's viewport, it may not be sufficient. For example, although in the browser's viewport, a region displaying an advertisement may be obscured from the user as a result of being in a background tab or for another reason. Thus, in general, a region is considered “in view” if it is viewable by a user and “not-in-view” if it is not viewable by a user, whatever the reason may be. The system and methods of the present technology use a monitoring element including a plug-in or applet (e.g., adobe flash), and JavaScript (or other common programming language, code, or API) resident on or embedded in the client device (e.g., personal computers) in combination to determine if the advertisements placed on a web page are “in-view” or not. In some implementations, the system and methods of the present technology intentionally superimpose one or more invisible animation frames over a screen area occupied by an advertisement and rely on them to determine if the advertisement is in-view. Each super-imposed animation has access to data regarding “view-ability” that would otherwise be inaccessible to the code (e.g., JavaScript) measuring “in-view” status. The code (e.g., JavaScript), by examining the frame rate of the animation, is configured to determine if the advertisement on which the animation is superimposed is in fact “in-view.”

In some implementations, the present technology is configured inside a Flash object (ActionScript) or code (e.g. JavaScript) associated with an advertisement (collectively referred to as a visibility plug-in) to initiate a process, also in some instances via a code (e.g., JavaScript), to signal an analytics and visibility server or a network resident (external to the computer running the browser) database with the information that a particular advertisement has rendered “in-view” in a particular web page, in a particular browser, for a measured duration of time. Recent versions of the Flash browser plug-in reduce the frame rates of Flash movies (“SWFs”) when they are not in-view on the screen in order to conserve system resources. The system and methods of the present technology use this characteristic to determine whether “SWF” files (animations) placed over, under, or near, an advertisement are in-view, and then use that information to infer whether the entire advertisement is in-view. Code within each of the animations measures the frame rate progression of the animations. When the animation is “in-view,” the average frame rate progression is in the range of 50-60 frames per second (fps). When the animation is out of view, the average frame rate progression is 2-4 fps. Using this information, the Flash animation is always aware of whether or not it is viewable on a viewer's screen. The animation code notifies the JavaScript of its view-ability status, and the JavaScript uses this information to determine whether the advertisement is “in-view,” according to the standard industry definition. The system and methods of the present invention can advantageously measure, monitor, or track whether or not a given advertisement is in-view for the entire duration that the advertisement is open on a page. Using the frame rate progression to measure view-ability also works in instances that the advertisement and the code are located inside a secure iframe and they do not have access to a publisher's web page. Thus the system and methods of the present invention can measure view-ability in situations where the tracking code is restricted from accessing information about the web page outside the iframe.

In the following description, for purposes of explanation, numerous specific details are indicated in order to provide a thorough understanding of the technology described. It should be apparent, however, to one skilled in the art, that this technology can be practiced without these specific details. In other instances, structures and devices are shown in block diagram form in order to avoid obscuring the technology. For example, the present technology is described with some embodiments or implementations below with reference to user interfaces and particular hardware. However, the present technology applies to any type of computing device that can receive data and commands, and any devices providing services.

Reference in the specification to “one embodiment or one implementation,” “an embodiment or implementation,” or “some embodiments or implementations” means simply that one or more particular features, structures, or characteristics described in connection with the one or more embodiments or implementations is included in at least one or more embodiments or implementations that are described. The appearances of the phrase “in one embodiment” or “in one implementation” in various places in the specification are not necessarily all referring to the same embodiment or implementation.

Some portions of the detailed descriptions that follow are presented in terms of method algorithms and symbolic representations of operations on data bits within a computer memory of either one or more computing devices typically used in the present technology. These algorithmic descriptions and representations are the means used by those skilled in the data processing and arts to most effectively convey the substance of their work to others skilled in the art. An algorithm as indicated here, and generally, is conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the following discussion, it should be appreciated that throughout the description, discussions utilizing terms such as “processing,” “computing,” “calculating,” “determining,” “transmitting,” or “displaying” or the like, refer to the actions and processes of a computer device or system or similar electronic computing device that manipulates and transforms data represented as physical (electronic) quantities within the computer device or system's registers and memories into other data similarly represented as physical quantities within the computer system memories or registers or other such information storage, transmission, or display devices.

The present technology also relates to system architecture for performing the operations described here. This system architecture may be specially constructed for the required purposes or methods stated here, or it may comprise a general-purpose computer selectively activated or reconfigured by a computer program stored in the computer. Such a computer program may be stored in a computer-readable storage medium, such as, but not limited to, any type of disk including floppy disks, optical disks, CD-ROMs, magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

This technology may take the form of an entirely hardware embodiment, an entirely software embodiment, or an embodiment including both hardware and software components. In some embodiments, this technology is implemented in software, which includes but is not limited to firmware, resident software, microcode, etc.

Furthermore, at least portions of this technology may take the form of one or more computer program products accessible from a computer-usable or computer-readable medium providing program code for use by or in connection with a computer or any instruction execution system. For the purposes of this description, a computer-usable or computer-readable medium may be any apparatus that can include, store, communicate, propagate, or transport the program for use by or in connection with the instruction execution system, apparatus, or device. The components used in systems and networks may use a data processing system suitable for storing and/or executing program code including at least one processor coupled directly or indirectly to memory elements through a system bus. The memory elements may include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) may be coupled to the system architecture either directly or through intervening I/O controllers.

Communication units including network adapters may also be coupled to the systems to enable them to couple to other data processing systems or storage devices, through either intervening private or public networks. Modems, cable modems, and Ethernet cards are just a few examples of the currently available types of network adapters.

Finally, the algorithms and operations presented in this application are not inherently related to any particular computer or other apparatus. Various general-purpose systems may be used or modified with programs in accordance with the teachings here, or it may prove convenient to construct more specialized apparatus to perform the required method steps. The required structure for a variety of these systems is outlined in the description below. In addition, the present technology is not described with reference to any particular programming language. It should be understood that a variety of programming languages may be used to implement the technology as described here.

The present technology is now described more fully with reference to the accompanying figures, in which several embodiments of the technology are shown. The present technology may be embodied in many different forms and should not be construed as limited to the embodiments set forth herein. Rather, these embodiments are provided so that this disclosure will be thorough and complete and will fully convey the invention to those skilled in the art.

One skilled in the art will recognize that methods, apparatus, systems, data structures, and computer-readable media that implement the features, functionalities, or modes of usage described herein. For instance, an apparatus embodiment can perform the corresponding steps or acts of a method embodiment.

### System Architecture Overview

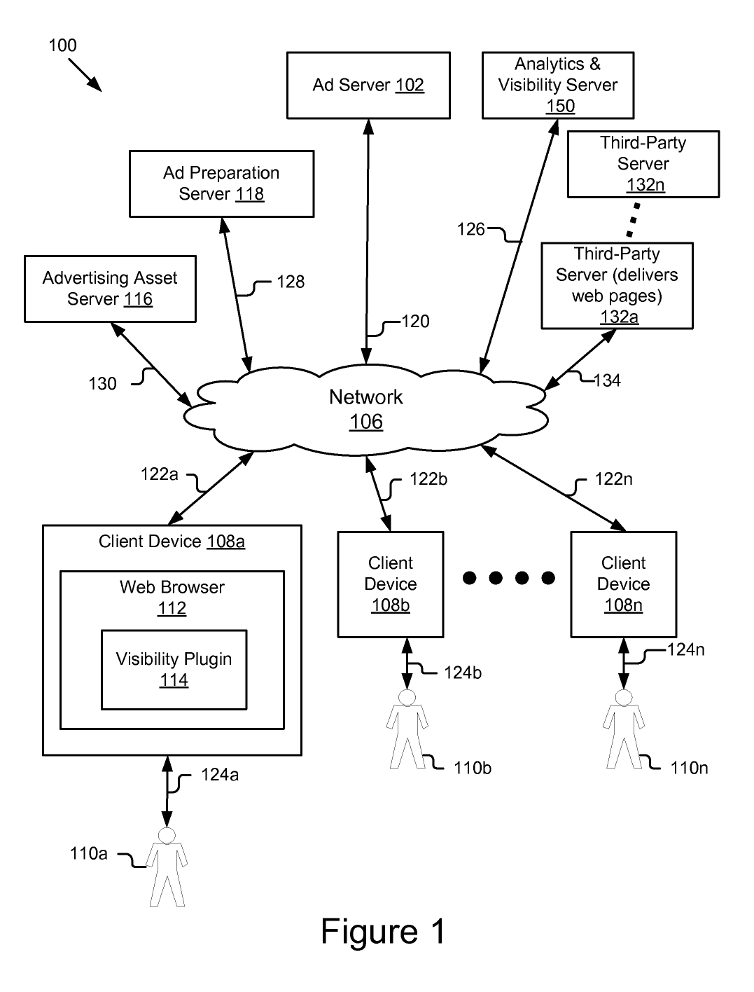

FIG. 1 illustrates a block diagram of an example advertising system architecture 100 in accordance with the present invention. The advertising system architecture 100 is configured to advantageously collect and present advertising analytics for online delivery of advertising. For many of the examples described in the specification below, an online advertisement (or “ad”) may be any text, picture, or video (with dynamic images), the purpose of which is advertising communication including any flash asset, any image of Internet Advertising Board (IAB) or industry standard width and height that is clickable including any recursion into iframes from the original page. It should be recognized that an advertisement may also include one or more hyperlinks, so that when a particular advertisement is rendered by a client (or consumer) device, it is possible to select these hyperlinks in order to be redirected to further content provided by an advertiser. A particular advertisement may be encoded by an advertiser as a HyperText Mark-up Language (HTML) file.

The illustrated “ad” system 100 includes an “Advertising-Asset” server 116 (hereafter “advertising-asset” server), an “Ad-Preparation” (hereafter “ad-preparation” server) server 118, an “Ad Server” (hereafter “ad” server) 102 a network 106, one or more “Third-Party” (hereafter “third-party” servers) servers 132, and one or more client devices 108a-108n that are accessed by users 110a-110n. In the illustrated embodiment, these entities are communicatively coupled via a network 106. Although only three client devices 108a-n are illustrated, it should be recognized that any number of client devices 108n are available to any number of users 110n. Furthermore, while only one network 106 is coupled to the advertising-asset server 116, the ad-preparation server 118, the ad server 102, the analytics-and-visibility server 150, the third-party servers 132a-n, and the one or more client devices 108a-108n, in practice any number of networks 106 can be connected to the entities.

In one embodiment, the advertising-asset server 116, the ad-preparation server 118, the ad server 102, the analytics-and-visibility server 150, and the third-party server 132a-n are hardware servers including a processor, memory, and network communication capabilities. Although only three third-party servers 132 are shown, the system 100 may include one or more third-party servers 132.

The network 106 is a conventional type, wired or wireless, and may have any number of configurations such as a star configuration, token ring configuration or other configurations. Furthermore, the network 106 may comprise a local area network (LAN), a wide area network (WAN) (e.g., the Internet), and/or any other interconnected data path across which multiple devices may communicate. In yet another embodiment, the network 106 may be a peer-to-peer network. The network 106 may also be coupled to or includes portions of a telecommunications network for sending data in a variety of different communication protocols. In yet another embodiment, the network 106 includes Bluetooth communication networks or a cellular communications network for sending and receiving data such as via short messaging service (SMS), multimedia messaging service (MMS), hypertext transfer protocol (HTTP), direct data connection, WAP, email, etc.

The client (or consumer, user, or viewer) device 108a is representative of client devices 108a-108n and is a conventional type of computing device, for example, a personal computer, a hardware server, a laptop computer, a tablet computer, or smart phone. The client devices 108a-108n are illustrated, as coupled to the network 106, by signal lines 122a-122n, respectively. In one embodiment, the client device 108 (e.g., 108a) is coupled to receive online advertisements from the ad server 102 and other content from publishing sites or third-party servers 132. The client device 108 (e.g., 108a) includes a web browser 112 for presenting online content and advertisements to the user (e.g., 110a). The web browser 112 presents advertisements and other content, and receives input from the user 110a (e.g. from 110a-110n) as represented by signal line 124 (e.g., 124a). The web browser 112 is configured to provide access to a hosted web page. The web page may comprise a main area in which content is displayed and an advertisement. In some instances, the advertisement may be contained within an iframe. In many instances, only elements of the web page that appear within a viewable portion of the browser window may be viewable to a user at a particular time. Elements which are not contained within a viewable portion of the browser window are not in-view.

A user accessing the web page via the web browser 112 will be able to move the browser window around the web page to view different elements of the web page. The position of the browser window is indicated by scroll bars, with which a user may also be able to zoom in or zoom out of the host web page, by which a user can effectively change the size of the browser window relative to the host web page. As a result of these user actions, certain elements of the web page will either be in view at particular times and not in view at other times.

The web browser 112 and visibility plug-in 114 are operable on the client device 108 (e.g., 108a). The visibility plug-in 114 may be configured to include a Flash Object, an ActionScript, or a JavaScript and associate any of these with a particular advertisement to initiate a process (e.g., a JavaScript), to signal an analytics and visibility server 150 or in some instances a network resident (external to the computer running the browser) database with the information that a particular advertisement has rendered “in-view” in a particular webpage or in a particular browser, for a measured duration of time. Recent versions of a Flash browser plug-in are configured to reduce the frame rates of Flash movies (“SWFs”) when they are not in view on the screen in order to conserve system resources. The system and methods of the present technology use this characteristic to determine whether “SWF” files or animations that are placed over, under, or near an advertisement are “in-view,” and then use that information to infer whether the entire advertisement is “in-view.” Code placed within each of the animations measures the frame rate of the animations. When a particular animation is “in-view,” the average frame rate is typically in the range of 50-60 frames per second (fps). When a particular animation is “out-of-view,” the average frame rate is typically 2-4 fps. Using this information, the Flash animation invariably indicates whether or not it is viewable on a screen. The animation code notifies the JavaScript of its “viewability” status, and the JavaScript uses this information to determine whether the advertisement is “in-view,” according to the standard industry definition. The end result is that the system and method of the present invention can measure whether or not a given advertisement is “in-view” for the entire duration that the advertisement is open on a webpage. By using a frame rate to measure “view-ability,” the visibility plug-in 114 is configured to make a determination even if the advertisement and the code are located inside a secure iframe, and do not have access to a particular publisher's webpage. The system and methods of the present invention are configured to measure “view-ability,” in situations where the tracking code is restricted from accessing information about a particular webpage outside the iframe.

The advertising-asset server 116 is a computer program operating on a hardware system for storing and providing advertisements or assets to other systems that will ultimately deliver or serve the advertisements to a particular end user. The advertising-asset server 116 is coupled to the network 106 by signal line 130 to illustrate receiving advertisements or assets from advertisers. In one embodiment, the advertising-asset server 116 is also configured to store the advertisements or assets that will be delivered or served to the client devices 108(a-n) for viewing. For example, the asset may include an advertisement copy, advertisement content, JavaScript or Flash that when executed by the client device 108(a-n) in the web browser 112 presents the advertisement to the user 110 as designed by and intended by the advertiser. The advertisers interact or communicate with the advertising-asset server 116 to upload and store advertisements on the advertising-asset server 116. These advertisements are then available for delivery and serving to the ad-preparation server 118 or the ad server 102, which in turn process the advertisements and deliver them to the client device 108(a-n).

The ad-preparation server 118 is a computer program operating on a hardware system for preparing advertisements for ultimate delivery to the client devices 108(a-n). In one embodiment, the ad-preparation server 118 may be configured to retrieve advertisements from the advertising-asset server 116 and modify them (e.g., by adding a script). The modified advertisements are then delivered by the ad-preparation server 118 to the ad server 102 for combination with content and delivery to the client device 108(a-n). The ad-preparation server 118 is coupled to the network 106 by signal line 128 for communication with the advertising-asset server 116 and the ad server 102.

The ad server 102 is a computer program operating on a hardware system for placing advertisements on websites. For example, the ad server 102 may be a web server that receives advertisements from the ad-preparation server 118 or the advertising-asset server 116 and delivers them to website visitors. The ad server 102 is coupled to the network 106 by signal line 120 for receiving advertisements from the ad-preparation server 118 or the advertising-asset server 116 and for delivering and serving the advertisements to third-party servers 132(a-n), sites or domains (not shown).

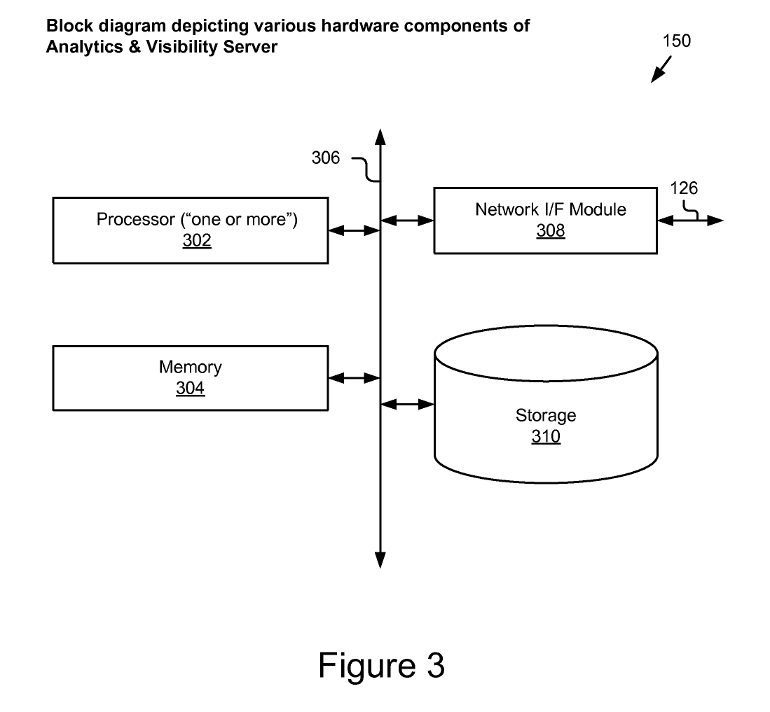

The analytics and visibility server 150 includes a computer program operating on a hardware system configured to receive data from the visibility plugin 114 on whether particular advertisements are in-view or not. The analytics and visibility server 150 is described in more detail with reference to FIG. 3. The analytics and visibility server 150 is coupled by signal line 126 to the network 106 for communication with client devices 18a-108n and ad server 102.

Referring now to FIG. 3, the hardware system of the analytics and visibility server 15 may comprise one or more processors 302, memory 304, bus 306, a network (I/F) module 308 and storage 310. The one or more processors 302 comprise an arithmetic logic unit, a microprocessor, a general-purpose controller or some other processor array to perform computations and provide electronic display signals for viewing on a client device 18a. The one or more processors 302 are coupled to the bus 306 for communication with the other components. The one or more processors 302 process data signals and may comprise various computing architectures including a complex instruction set computer (CISC) architecture, a reduced instruction set computer (RISC) architecture, or an architecture implementing a combination of instruction sets. Although only a single processor is shown in FIG. 3, multiple processors may be included as indicated by the indication one or more. Other processors, operating systems, sensors, displays and physical configurations are possible.

The memory 304 stores instructions and/or data that may be executed by the one or more processors 302. The memory 304 is coupled to the bus 306 for communication with the other components. The instructions and/or data may comprise code for performing any and/or all of the techniques described herein. The memory 304 may be a dynamic random access memory (DRAM) device, a static random access memory (SRAM) device, flash memory or some other memory device.

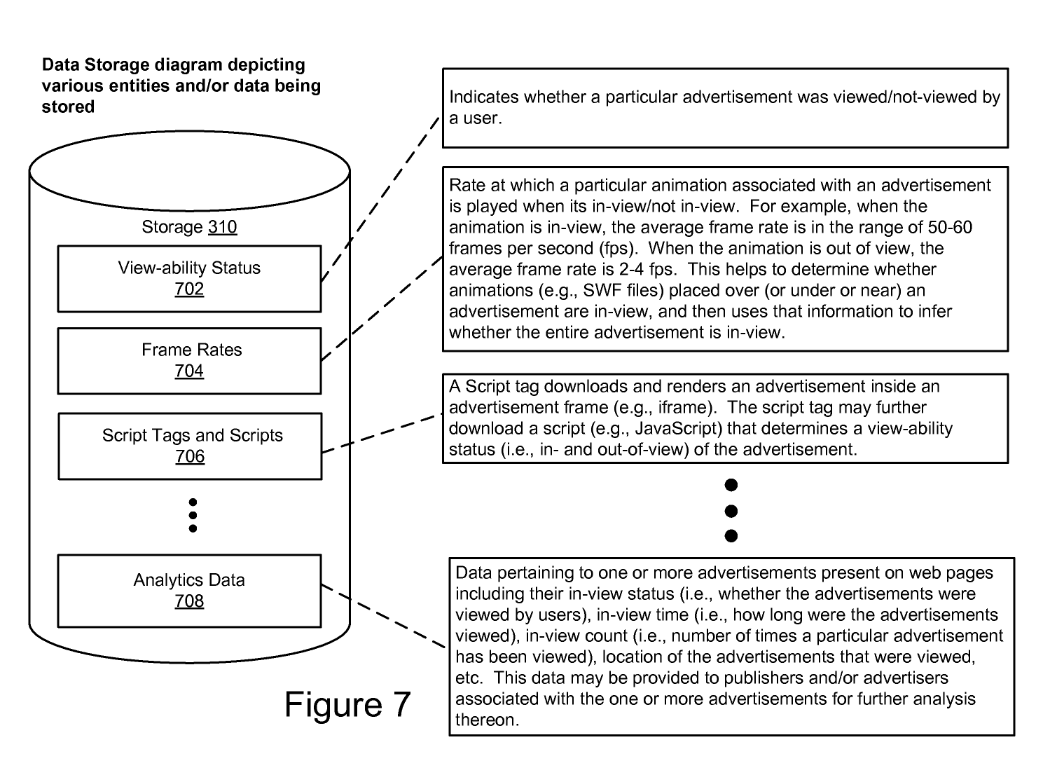

The network interface (I/F) module 308 is coupled to network 106 by signal line 126 and coupled to the bus 306. The network interface module 308 includes ports for wired connectivity such as but not limited to USB, SD, or CAT-5, etc. The network interface module 308 links the one or more processors 302 to the network 106 that may in turn be coupled to other processing systems. The network interface module 308 provides other connections to the network 106 using standard network protocols such as TCP/IP, HTTP, HTTPS and SMTP. In other embodiments, the network interface module 308 includes a transceiver for sending and receiving signals using Wi-Fi, Bluetooth® or cellular communications for wireless communication. The network interface (I/F) module 308 provides a communication path for the components of analytics and visibility server 150. The data storage 310 stores any data acquired or obtained from the visibility plugin 114. Examples of the types of data are described later with reference to FIG. 7.

### Client Device 108a-n

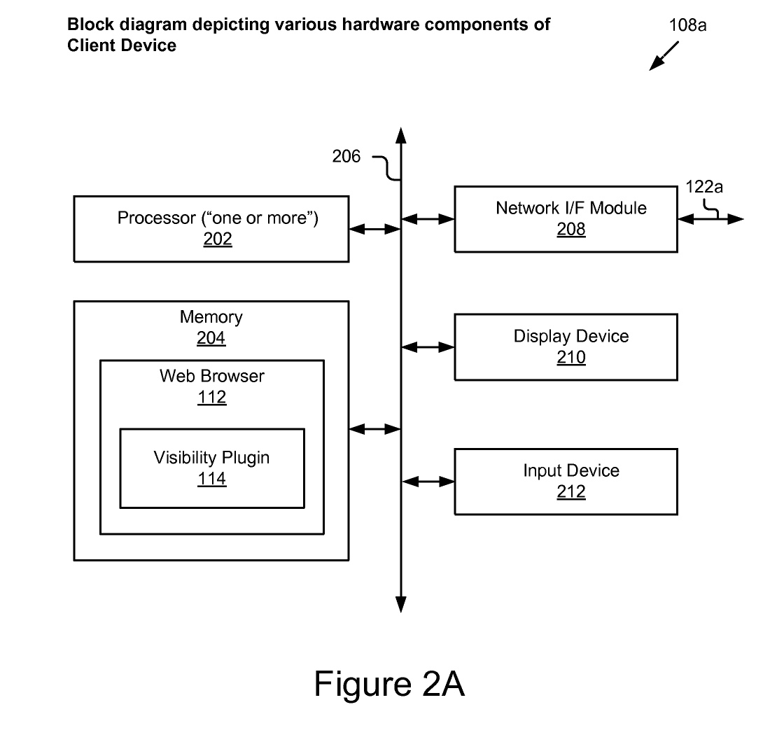

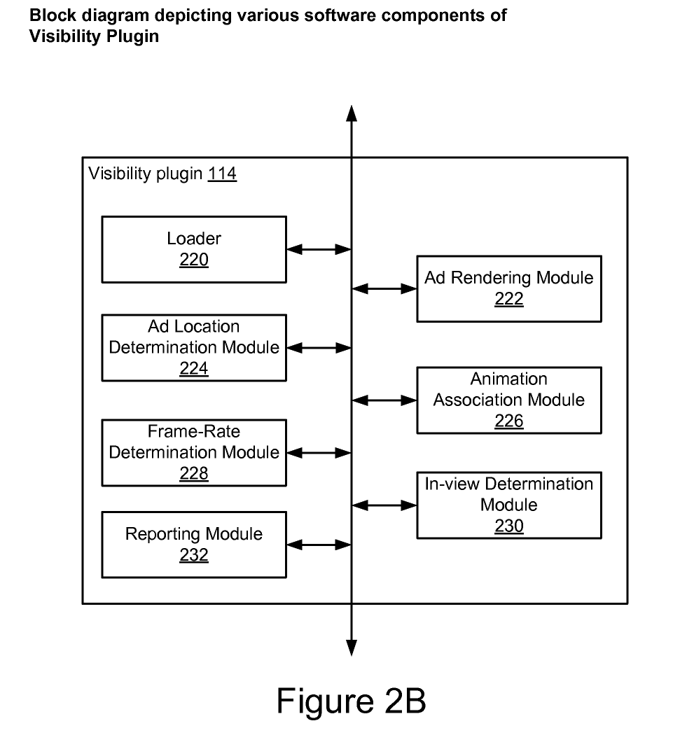

FIG. 2A is a block diagram of one embodiment of the client device 108a. In this embodiment, the client device 108a (or any through 108n) comprises: one or more processors 202, memory 204, a bus 206, a network interface (I/F) module 208, display device 210, and an input device 212.

The one or more processors 202 comprise an arithmetic logic unit, a microprocessor, a general-purpose controller or some other processor array to perform computations and provide electronic display signals to the display device 210. The one or more processors 202 are coupled to the bus 206 for communication with the other components. The one or more processors 202 process data signals and may comprise various computing architectures including a complex instruction set computer (CISC) architecture, a reduced instruction set computer (RISC) architecture, or an architecture implementing a combination of instruction sets. Although only a single processor is shown in FIG. 2A, multiple processors may be included as indicated by the indication one or more. Other processors, operating systems, sensors, displays and physical configurations are possible.

The memory 204 stores instructions and/or data that may be executed by the one or more processors 202. The memory 204 is coupled to the bus 206 for communication with the other components. The instructions and/or data may comprise code for performing any and/or all of the techniques described herein. The memory 204 may be a dynamic random access memory (DRAM) device, a static random access memory (SRAM) device, flash memory or some other memory device. In some embodiments, the memory 204 stores the web browser 112 which includes the visibility plugin 114.

The network interface (I/F) module 208 is coupled to network 106 by signal line 122a (or 122b through 122n) and coupled to the bus 206. The network interface module 208 includes ports for wired connectivity such as but not limited to USB, SD, or CAT-5, etc. The network interface module 208 links the one or more processors 202 to the network 106 that may in turn be coupled to other processing systems. The network interface module 208 provides other connections to the network 106 using standard network protocols such as TCP/IP, HTTP, HTTPS and SMTP. In other embodiments, the network interface module 208 includes a transceiver for sending and receiving signals using Wi-Fi, Bluetooth® or cellular communications for wireless communication. The network interface (I/F) module 208 provides a communication path for the components of the client device 108a (or 108b through 108n) to the network 106 and other systems.

In the client-server implementation shown in FIGS. 1, the present technology manifests inside a Flash Object (or ActionScript) or JavaScript associated with a particular advertisement (collectively referred to as a visibility plug-in 114) to initiate a process, also in some instances a JavaScript, to signal an analytics and visibility server 150 or a network resident (external to the computer running the browser) database with the information that a particular advertisement has rendered in-view in a particular web page, in a particular browser, for a measured duration of time. Recent versions of the Flash browser plug-in are configured to reduce the frame rates of Flash movies (SWFs) when they are not in view on the screen in order to conserve system resources. The system and method of the present technology use this characteristic to determine whether SWF files (or animations) placed over, under or near an advertisement are in-view, and then use that information to infer whether the entire advertisement is in-view.

Code within each of the animations measures the frame rate of the animations. When an animation is in-view, the average frame rate is in the range of 50-60 frames per second (fps). When an animation is out of view, the average frame rate is 2-4 fps. Using this information, the Flash animation is always aware of whether or not it is viewable on the screen. The animation code notifies the JavaScript of its viewability status, and the JavaScript uses this information to determine whether an advertisement is in-view, according to the standard industry definition. The end result is that the system and method of the present invention can measure whether or not a given advertisement is in-view for the entire duration that the ad is open on a page.

Using a frame rate to measure viewability works even if the advertisement and the code are located inside of a secure iframe, and do not have access to the publisher's page. Thus the system and method of the present invention can measure view-ability in situations where the tracking code is restricted from accessing information about the page outside the iframe.

Referring now to FIG. 2B, the visibility plugin 114 further comprises a loader 220, an “Ad-Rendering Module” (hereafter “ad-rendering module”) 222, an “Ad-Location-Determination Module” (hereafter “ad-location-determination module”) 224, an “Animation-Association Module” (hereafter “animation-association module”) 226, a “Frame-Rate-Determination Module” (hereafter “frame-rate determination module”) 228, an “In-view-Determination Module” (hereafter “in-view-determination module”) 230 and a “Reporting Module” (hereafter “reporting module”) 232. The visibility plugin 114 uses JavaScript to measure advertisement view-ability using flash movies. The loader 220 may be an advertisement server script tag configured to download and render a creative (i.e., the picture comprising the advertisement itself) inside an iframe. The ad-rendering module then discovers the script tag, which downloads the JavaScript, which begins to execute inside the web browser 112 (FIG. 1). The ad-location-determination module 224, with the JavaScript finds the advertisement inside the iframe that called it. The animation-association module 226, using the JavaScript places one or more Flash files or animations in locations within the iframe suitable to measure view-ability according to industry standards. These may be positioned behind or in front of a particular advertisement, evenly or unevenly spaced, and may be moved from time to time or remain static. The animations may be configured to be 1×1 in dimension or greater. The frame-rate determination module 228 is configured to enable calls by the animations to the JavaScript notifying it whenever their view-ability status changes. The in-view determination module 230 using the JavaScript is configured to use the information about which animations are in and out-of-view in order to determine whether or not a particular advertisement is in-view, based on the standard industry definition. The reporting module 232 uses the JavaScript to send in-view status along with other information back to the analytics and visibility server 150 for processing, aggregation, and storage.

In some implementations, the tracking code is not implemented as external JavaScript, but instead is implemented as Action-Script code residing or embedded inside the advertisement itself. In this instance, the code uses the frame rate of the advertisement itself, or frame rates of movie clips inside the advertisement, in order to determine view-ability. The system and method of the present invention then use Flash networking libraries, including XML Socket, URL Loader, and JavaScript (via External Interface) to send view-ability data back to the analytics and visibility server 150 for processing and aggregation.

### Example Methods Overview

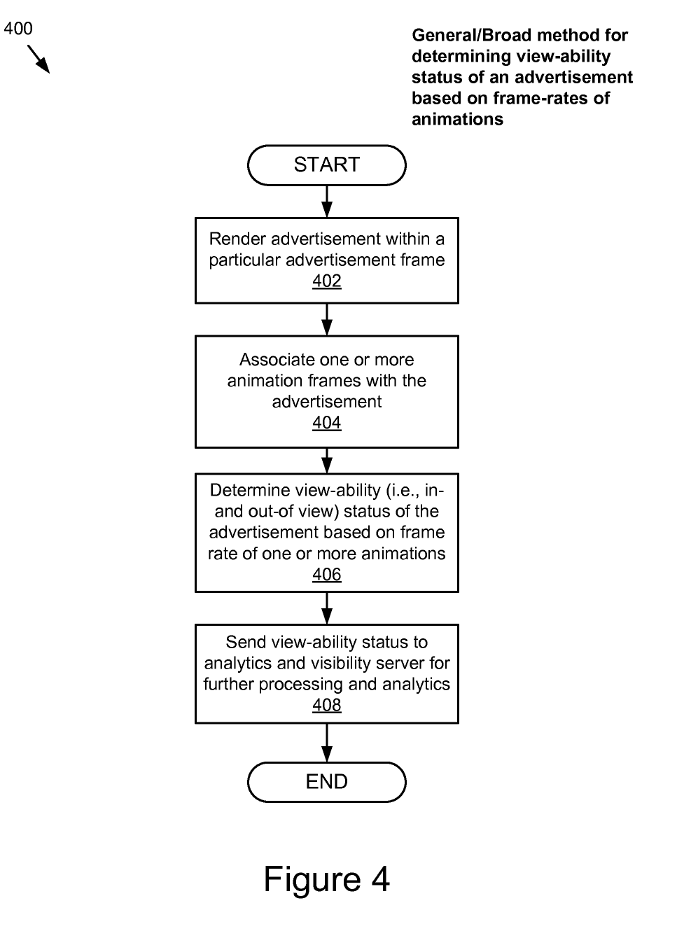

Referring now to FIG. 4, an example general method indicated by reference numeral 400 for determining visibility status of an advertisement based on evaluating the frame-rates of animations is illustrated. The method 400 begins (to indicate a start to a subroutine or program for implementing the functionality described) and proceeds to block 402, including one or more operations for rendering an advertisement within a particular advertisement frame. The method 400 proceeds to the next block 404 including one or more operations for associating one or more animation frames with the advertisement. From there, the method 400 proceeds to the next block 406, including one or more operations for determining view-ability (i.e., whether in or out-of-view) status of the advertisement based on the frame rate of one or more of the animations. The method 400 proceeds to the next block 408, including one or more operations for sending the view-ability status to the analytics and visibility server 150 for further processing and analysis. From there this subroutine or program ends or may be transferred to other operations. It should be recognized that the operations indicated in this flow chart are by way of example, and the order of the operations may be changed or any operation may be eliminated.

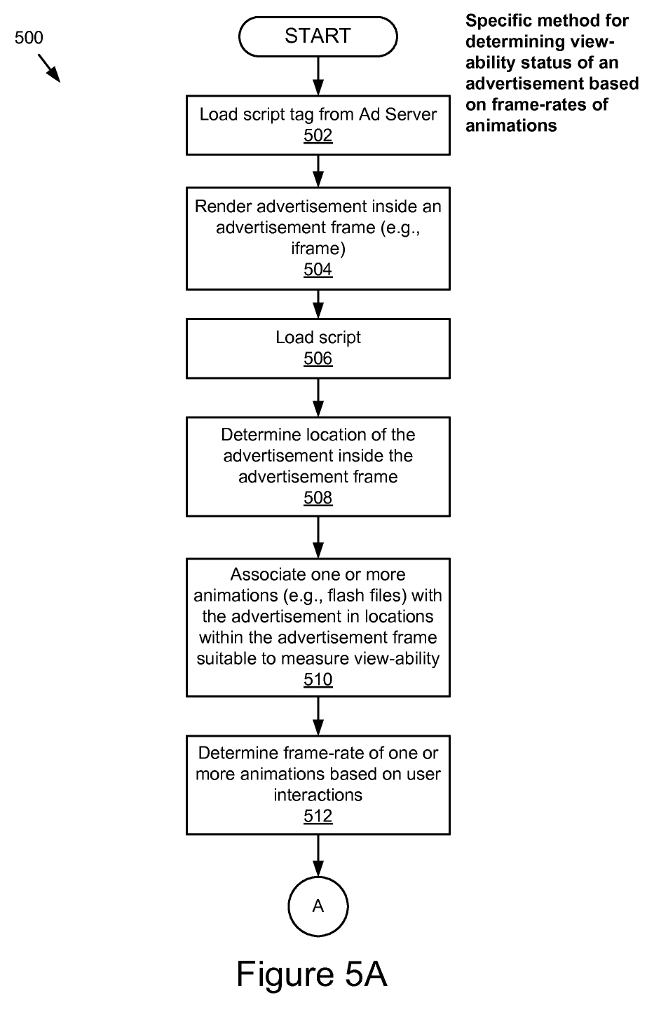

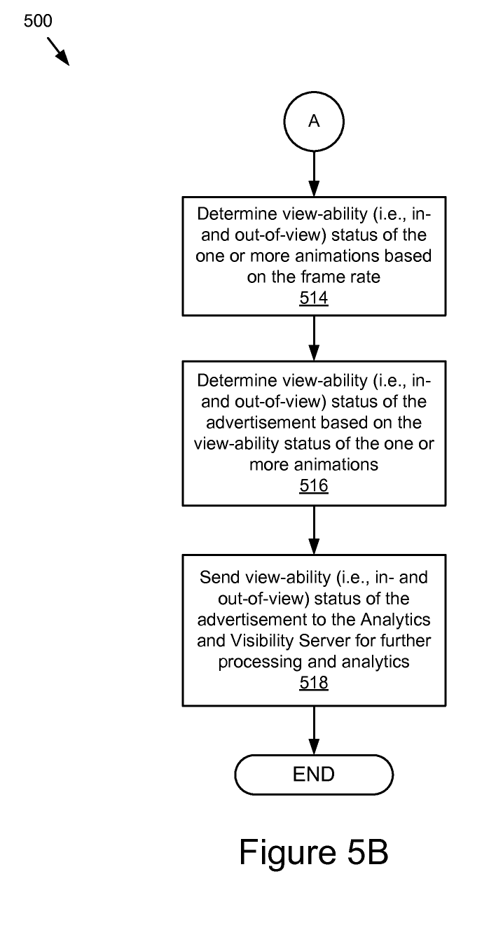

Referring now to FIGS. 5A and 5B, an example specific method 500 for determining view-ability status of any particular advertisement by considering the frame-rates of animations is illustrated. To that end, the specific method 500 begins and proceeds to block 502, including one or more operations for loading a script tag from an ad server (e.g., 102). The method 500 proceeds to the next block 504 including one or more operations for rendering an advertisement inside an advertisement frame (e.g., an iframe). From there, the method 500 proceeds to a next block 506 including one or more operations for loading a script. The method 500 proceeds to a next block 508 including one or more operations for determining a location for the advertisement inside the advertisement frame. The method 500 proceeds to the next block 510 including one or more operations for associating one or more animations (e.g., flash files) with the advertisement in locations within the advertisement frame suitable to measure view-ability. From there, the method 500 proceeds to the next block 512 including one or more operations for determining a frame-rate of one or more animations based on user interactions. The method 500 via connector “A” proceeds to FIG. 5B. Referring now to FIG. 5B, the method 500 proceeds to a block 514 including one or more operations for determining view-ability (i.e., in and out-of-view) status of the one or more animations based on the frame rate. The method 500 proceeds to the next block 516 including one or more operations for determining view-ability (i.e., in and out-of-view) status of the advertisement based on the view-ability status of the one or more animations. The method 500 proceeds to the next block 518 including one or more operations for sending view-ability (i.e., in and out-of-view) status of the advertisement to the analytics and visibility server 150 for further processing and analysis. From there the method 500 ends this subroutine or program to perform this functionality. It should be recognized that the operations indicated in this flow chart are by way of example, and the order of the operations may be changed or any operation may be eliminated.

### Example Graphical Representation of Browser and Advertisement and Data Storage

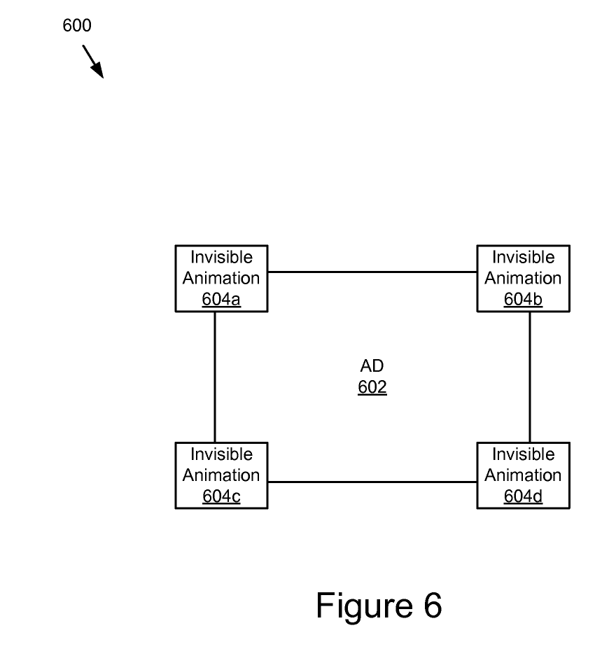

FIG. 6 illustrates an example browser 600 with an advertisement 602 and several animation frames. The smaller boxes 604a, 604b, 604c, and 604d are the animation frames playing a movie. If the animation frames are in-view, their frame rate goes to a predictable level. Thus, the in-view status of the advertisement may be inferred from the in-view status of the small movies placed around it. In this illustrated embodiment, four animation frames located proximate the corner of each advertisement are used. In other embodiments, a single animation frame at the advertisement center may be used or two animation frames, one near the top and the other near the bottom of the advertisement, may be used. It should be recognized that any number of frames may be used, one or more as desired, and the animation frames may be 1×1 in size, or greater.

FIG. 7 illustrates an example data storage 310 with various examples of criteria for data stored. The data storage 310 may be configured to store data on view-ability status, indicated by reference numeral 702. This data reflects whether a particular advertisement was viewed or not viewed by a user, consumer, viewer, or client. A section of the data storage 310 is configured to store d data on frame rates, as indicated by reference numeral 704. Examples of this type of data include the rate at which a particular animation associated with an advertisement is played when it is in-view or not in-view. For example, when a particular animation is in-view, the average frame rate may be in the range of 50-60 frames per second (fps). When the animation is out-of-view, the average frame rate is 2-4 fps. This helps to whether animations (e.g., SWF files) placed over, under, or near an advertisement are in-view, and then uses that information to infer whether the entire advertisement is in-view. A section of the data storage 310 stores script tags and scripts 706. A script tag may download and render an advertisement inside an advertisement frame or a restricted area in which an advertisement is displayed (e.g., iframe). The script tag may further download a script (e.g., JavaScript), which determines a view-ability status (i.e., in and out-of-view) of the advertisement. Another section of the data storage 310 may store analytics data, as indicated by reference numeral 708. This data may pertain to one or more advertisements present on web pages including their in-view status (i.e., whether the advertisements were viewed by users), in-view time (i.e., how long were the advertisements viewed), in-view count (i.e., a number of times that a particular advertisement has been viewed), location of the advertisements that were viewed, etc. This data may be provided to publishers and/or advertisers associated with the one or more advertisements for further analysis.

It should be recognized that the preceding description of the various embodiments of the present technology has been presented for the purposes of illustration and description. It is not intended to be exhaustive or to limit the present technology to the precise form disclosed. Many modifications and variations are possible in light of the above teaching. It is intended that the scope of the present technology be limited not by this detailed description, but rather by the claims of this application. As should be understood by those familiar with the art, the present technology may be embodied in other specific forms, without departing from the spirit or essential characteristics thereof. Likewise, the particular naming and division of the blocks, routines, features, attributes, methodologies, and other aspects are not mandatory or significant, and the mechanisms that implement the present disclosure or its features may have different names, divisions and/or formats. Furthermore, as should be apparent to one of ordinary skill in the relevant art, the blocks, routines, features, attributes, methodologies and other aspects of the present technology can be implemented as software, hardware, firmware, or any combination of the three. Also, wherever a component, an example of which is illustrated by a block, of the present technology is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present technology is in no way limited to implementation in any specific programming language, or for any specific operating system or environment. Accordingly, the disclosure of the present technology is intended to be illustrative, but not limiting, of the scope of the present disclosure, which is set forth in the following claims.

1. A computer-implemented method performed over a network connecting a display device with an analytics and visibility server for monitoring hosted web pages for determining whether an area bearing advertising within a hosted web page is in-view on the display device, comprising:
loading a script tag including code from an ad server associated with advertising by a user interface on the display device, the code configured to initiate a signal to the analytics and visibility server upon rendering a particular advertisement inside an advertisement frame, the instance of the particular advertisement rendered to be in-view on the display device for a measured duration of time, causing the script tag to measure in-view status of at least a portion of the area bearing the advertising rendered in the area;
superimposing a plurality of invisible animation frames on portions of the area bearing the advertising in the area, wherein each super-imposed animation has access to viewability data that is inaccessible to the code;
rendering the hosted web page on the display device;
monitoring a frame rate progression characteristic relating to each invisible animation frame;
determining from the frame rate progression characteristic for each invisible animation frame, whether the area bearing the advertising is in-view or not in-view on the display device, wherein the frame rate progression characteristic for each invisible animation frame varies according to whether the at least one invisible animation frame is in-view or not in view, wherein monitoring the frame rate progression of the invisible animation frames is performed at a client device where a user views the advertising; and
using animation code within each of the animations to measure the frame rate of the animations, by making a determination whether the advertising in in-view or not in-view, wherein an animation is determined to be in-view when an average frame rate progression is in the range of 50-60 frames per second (fps) and an animation is determined to be not in-view when the average frame rate progression is 2-4 fps and wherein the animation code notifies the script of its viewability status.

2. A computer-implemented method according to claim 1, wherein the advertising includes one or more advertisements displayed on a hosted web page.

3. The computer-implemented method of claim 2, wherein the advertisements include at least one of text, picture, and video.

4. The computer-implemented method according to claim 2, wherein the one or more advertisements include one or more hyperlinks leading to more information on the one or more advertisements.

5. The computer-implemented method of claim 1, wherein monitoring the frame rate progression characteristic is performed by code operating in a restricted environment preventing the code from discovering features of the hosted web page.

6. The computer-implemented method of claim 5, wherein the restricted environment is an iframe.

7. The computer-implemented method of claim 1, wherein the invisible animation frames is a small web format file.

8. The computer-implemented method of claim 7, further comprising:
determining a frame-rate of one or more animations based on user interactions and making a determination whether animations placed over, under, and near an advertisement are in-view, and using the determination to infer whether the entire advertisement is in-view.

9. A computer-program product for determining whether an area bearing advertising within a hosted web page is in-view on a display device connected to an analytics and visibility server for monitoring the hosted web page, comprising a non-transitory computer-useable medium including a computer-readable program, wherein the computer-readable program when executed on a computer causes the computer to:
load a script tag including code from an ad server associated with advertising by a user interface on the display device, the code configured to initiate a signal to the analytics and visibility server when a particular advertisement has rendered to be in-view on the display device for a measured duration of time, the script tag configured to measure in-view status of at least a portion of the area bearing the advertising rendered in the area;
superimpose at least one invisible animation frame on at least a portion of the area bearing the advertising, wherein the super-imposed animation has access to viewability data that is inaccessible to the code;
render the web page by a browser on the display device;
monitor a frame rate progression characteristic relating to the at least one invisible animation frame; and
determine from the frame rate progression characteristic whether the area bearing the advertising is in-view or not in-view, wherein the frame rate progression characteristic varies according to whether the at least one invisible animation frame is in-view or not in-view, wherein monitoring the frame rate progression of the invisible animation frames is performed at a client device where a user views the advertising; and
use animation code within each of the animations to measure the frame rate of the animations, by making a determination whether the advertising in in-view or not in-view, wherein an animation is determined to be in-view when an average frame rate progression is in the range of 50-60 frames per second (fps) and an animation is determined to be not in-view when the average frame rate progression is 2-4 fps and wherein the animation code notifies the script of its viewability status.

10. A computer-program product according to claim 9, wherein the advertising includes one or more advertisements on a hosted web page.

11. A computer-program product according to claim 10, wherein the advertisements include at least one of text, picture, and video.

12. A computer-program product according to claim 10, wherein the one or more advertisements include one or more hyperlinks leading to more information on the one or more advertisements.

13. A computer-program product according to claim 9, wherein monitoring the frame rate progression characteristic is performed by code operating in a restricted area preventing the code from discovering features of the hosted web page

14. A computer-program product according to claim 13, wherein the restricted area is an iframe.

15. A computer-program product according to claim 14, wherein the iframe is served by a domain that is different than the host webpage wherein the iframe is contained.

16. A computer-program product according to claim 9, wherein the invisible animation frames is a small web format file.

17. A computer-program product according to claim 9, wherein the computer-readable program when executed on a computer further causes the computer to:
determine a frame-rate of one or more animations based on user interactions and making a determination whether animations placed over, under, and near an advertisement are in-view, and using the determination to infer whether the entire advertisement is in-view.

18. A system for determining whether an area bearing advertising within a hosted web page is in-view on a display device connected to an analytics and visibility server for monitoring the hosted web page, comprising:
a processor, and;
a memory storing instructions that, when executed, cause the system to:
loading a script tag including code from an ad server associated with advertising by a user interface on the display device, the code configured to initiate a signal to the analytics and visibility server when a particular advertisement has rendered to be in-view on the display device for a measured duration of time, the script tag configured to measure in-view status of at least a portion of the area bearing the advertising rendered in the area;
superimpose at least one invisible animation frame on at least a portion of the area bearing the advertising, wherein the super-imposed animation has access to viewability data that is inaccessible to the code;
render the web page by a browser on the display device;
monitor a frame rate progression characteristic relating to the at least one invisible animation frame; and
determine from the frame rate progression characteristic whether the advertising in the area is in-view or not in-view, wherein the frame rate progression characteristic varies according to whether the at least one invisible animation frame is in-view or not in view use animation code within each of the animations to measure the frame rate of the animations, by making a determination whether the advertising is in-view or not in-view, wherein an animation is determined to be in-view when an average frame rate progression is in the range of 50-60 frames per second (fps) and an animation is determined to be not in-view when the average frame rate progression is 2-4 fps and wherein the animation code notifies the script of its viewability status.

19. A system according to claim 18, wherein the advertising includes one or more advertisements on a hosted web page.

20. A system according to claim 19, wherein the advertisements include at least one of text, picture, and video.

21. A system according to claim 19, wherein the one or more advertisements include one or more hyperlinks leading to more information on the one or more advertisements.

22. A system according to claim 19, wherein the one or more advertisements on the hosted page are determined to be in view or not in view for the entire time the one or more advertisement are open on the hosted.

23. A system according to claim 18, wherein monitoring the frame rate progression characteristic is performed by code operating in a restricted area preventing the code from discovering features of the hosted web page

24. A system according to claim 23, wherein the restricted area is an iframe.

25. A system according to claim 18, wherein the invisible animation frames is a small web format file.

26. A system according to claim 18, wherein the memory stores further instructions that cause the system to:
determine a frame-rate of one or more animations based on user interactions and making a determination whether animations placed over, under, and near an advertisement are in-view, and using the determination to infer whether the entire advertisement is in-view.
